(19) United States
(12) Patent Application Publication
(10) Pub. No.: US 2013/0116942 A1
(43) Pub. Date: May 9, 2013

(54) LEAK ESTIMATION IN A GAS DELIVERY SYSTEM USING BLOCK LEAST-MEAN-SQUARES TECHNIQUE

(71) Applicants: Peter Douglas Hill, Eindhoven (NL); Birpal Singh Sachdev, Eindhoven (NL)

(72) Inventors: Peter Douglas Hill, Eindhoven (NL); Birpal Singh Sachdev, Eindhoven (NL)

(73) Assignee: KONINKLIJKE PHILIPS ELECTRONICS N.V., EINDHOVEN (NL)

(21) Appl. No.: 13/808,381

(22) PCT Filed: Jul. 5, 2011
(86) PCT No.: PCT/IB2011/052958

§ 371 Date: Jan. 4, 2013

Related U.S. Application Data
(60) Provisional application No. 61/362,442, filed on Jul. 8, 2010.

(51) Int. Cl. G01M 3/28

(52) U.S. Cl. CPC G01M 3/2846
USPC 702/51

(57) ABSTRACT

A method of estimating leak flow in a gas delivery system is provided that includes determining an average total flow Qₜₒₜ (or summation or integral of total flow) of the gas delivery system for each of N breaths, determining P^{γ1} and P^{γ2} for each of the N breaths, wherein P is a leak pressure of the gas delivery system, γ1 is a first predetermined value, γ2 is a second predetermined value, and P^{γ1} and P^{γ2} are averages for the breath (summation or integrals may also be used), setting up a system of N equations, one for each of the N breaths, wherein each of the equations has the form Qₜₒₜ=G_{orf}.P^{γ1}+G_{vg}.P^{γ2} and uses the determined Qₜₒₜ, P^{γ1} and P^{γ2} for the associated breath, solving the system of N equations for G_{orf} and G_{vg}, and using G_{orf} and G_{vg} to calculate instantaneous leak Qₗₑₐₖ using Qₗₑₐₖ=G_{orf}.P^{γ1}+G_{vg}.P^{γ2}

The present invention relates to gas delivery systems, such as positive pressure support systems and other ventilator (e.g., invasive) systems, and, more particularly, to a method for estimating leak in a gas delivery system, and a gas delivery system employing such a method.

There are numerous situations where it is necessary or desirable to deliver a flow of breathing gas non-invasively to the airway of a patient, i.e., without intubating the patient or surgically inserting a tracheal tube. Such therapies are commonly referred to as non-invasive ventilation (NIV) therapies. For example, it is known to non-invasively deliver continuous positive airway pressure (CPAP) or variable airway pressure, which varies with the patient's respiratory cycle, to treat medical disorders, such as obstructive sleep apnea (OSA), Obesity Hypoventilation Syndrome (OHS) and Chronic Obstructive Pulmonary Disease (COPD).

NIV therapies involve the placement of a patient interface device including a mask component on the face of a patient. The mask component may be, without limitation, a nasal mask that covers the patient's nose, a nasal pillow/cushion having nasal prongs that are received within the patient's nares, a nasal/oral mask that covers the nose and mouth, or a full face mask that covers the patient's face. The patient interface device interfaces the ventilator or pressure support device with the airway of the patient through one or more delivery conduits (together commonly referred to as a patient circuit) so that a flow of breathing gas can be delivered from the pressure/flow generating device to the airway of the patient.

NIV using a single limb patient circuit has safely ventilated patients with respiratory insufficiency for over ten years and those with severe sleep apnea for over twenty years. In NIV, an accurate estimate of the patient flow is required for consistent and accurate volume delivery and for the ventilator to sense the patient's respiratory drive. The accuracy of the estimated patient flow is dependent on three things: (i) the accuracy and precision of the total flow signal (which is measured at the ventilator outlet and which is the composite of the patient flow and the flow caused by leaks (both intentional and unintentional) about the patient interface), (ii) the accuracy and precision of the pressure measurement at the leak sources, and, (iii) the ability to model the leak flow as a function of one or more parameters such as pressure. Thus, one of the key technologies for effective NIV is the estimation of leak flow.

Recent clinical practice has begun to increase pressure support in NIV patients. Inspiratory Positive Airway Pressure (IPAP) levels above 30 cmH₂O where rarely used ten years ago but now have become common practice for COPD patients. These high pressure support levels amplify errors in the leak estimation. The two primary sources of leak estimation error are (1) noise in the pressure and flow data, and (2) that the assumed leak model is different than that of the actual leak model. In one current leak estimation methodology, known as Auto-Trak™, developed and employed by the assignee of the present invention, the leak model is assumed to be an orifice and the leak is proportional to P^{1/2}, wherein P is the patient pressure. However, the leaks that occur about the mask seals are typically proportional to P^{γ}, where γ is above 1.0. Thus, the actual leak behaves differently than that modeled by P^{1/2}, and the consequence of this leak error is to bias the estimated patient flow negative in the expiratory phase and to bias the estimated patient flow positive in the inspiratory phase. As a result, the triggering and cycling of the positive pressure therapy are desensitized.

The ability to estimate leak flow is also important in situations where it is necessary to deliver a flow of breathing gas to the airway of a patient invasively, i.e., wherein the patient is intubated or has a surgically inserted tracheal tube. Many of the problems with accurately estimating leak flow in NIV systems described above are present in invasive ventilation using a gas delivery system like an invasive ventilator system.

In one embodiment, a method of estimating leak flow in a gas delivery system is provided that includes determining a total flow value (Qtotᵥ) of the gas delivery system for each of N breaths, wherein Qtotᵥ is one of average total flow Q̅ₜ̅ₒ̅ₜ̅, summation of total flow or integral of total flow, determining a P^{γ1} value (P^{γ1}ᵥ) and a P^{γ2} value (P^{γ2}ᵥ) for each of the N breaths, wherein P is a leak pressure of the gas delivery system, γ1 is a first predetermined value, γ2 is a second predetermined value, wherein P^{γ1}ᵥ and P^{γ2}ᵥ are one of averages P̅^̅{̅γ̅1̅}̅ and P̅^̅{̅γ̅2̅}̅ for the breath, summations of P^{γ1} and P^{γ2} for the breath or integrals of P^{γ1} and P^{γ2} for the breath, setting up a system of N equations, one for each of the N breaths, wherein each of the equations has the form Qtotᵥ=G_{orf}·P^{γ1}ᵥ+G_{vg}·P^{γ2}ᵥ and uses the determined Qtotᵥ, P^{γ1}ᵥ and P^{γ2}ᵥ for the associated breath, solving the system of N equations for G_{orf} and G_{vg}, and using G_{orf} and G_{vg} to calculate instantaneous leak Qₗₑₐₖ using Qₗₑₐₖ=G_{orf}·P^{γ1}+G_{vg}·P^{γ2}.

In one particular, non-limiting exemplary embodiment, a method of estimating leak flow in a gas delivery system is provided that includes determining an average total flow Q̅ₜ̅ₒ̅ₜ̅ of the gas delivery system for each of N breaths, determining P̅^̅{̅γ̅1̅}̅ and P̅^̅{̅γ̅2̅}̅ for each of the N breaths, wherein P is a leak pressure of the gas delivery system, γ1 is a first predetermined value, γ2 is a second predetermined value, and P̅^̅{̅γ̅1̅}̅ and P̅^̅{̅γ̅2̅}̅ are averages for the breath, setting up a system of N equations, one for each of the N breaths, wherein each of the equations has the form Q̅ₜ̅ₒ̅ₜ̅=G_{orf}· P̅^̅{̅γ̅1̅}̅+G_{vg}· P̅^̅{̅γ̅2̅}̅ and uses the determined Q̅ₜ̅ₒ̅ₜ̅, P̅^̅{̅γ̅1̅}̅ and P̅^̅{̅γ̅2̅}̅ for the associated breath, solving the system of N equations for G_{orf} and G_{vg}, and using G_{orf} and G_{vg} to calculate instantaneous leak Qₗₑₐₖ using Qₗₑₐₖ=G_{orf}·P^{γ1}+G_{vg}·P^{γ2}.

In another embodiment, a gas delivery system is provided that is adapted/programmed to estimate leak flow in the gas delivery system using the method(s) just described.

These and other objects, features, and characteristics of the present invention, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention.

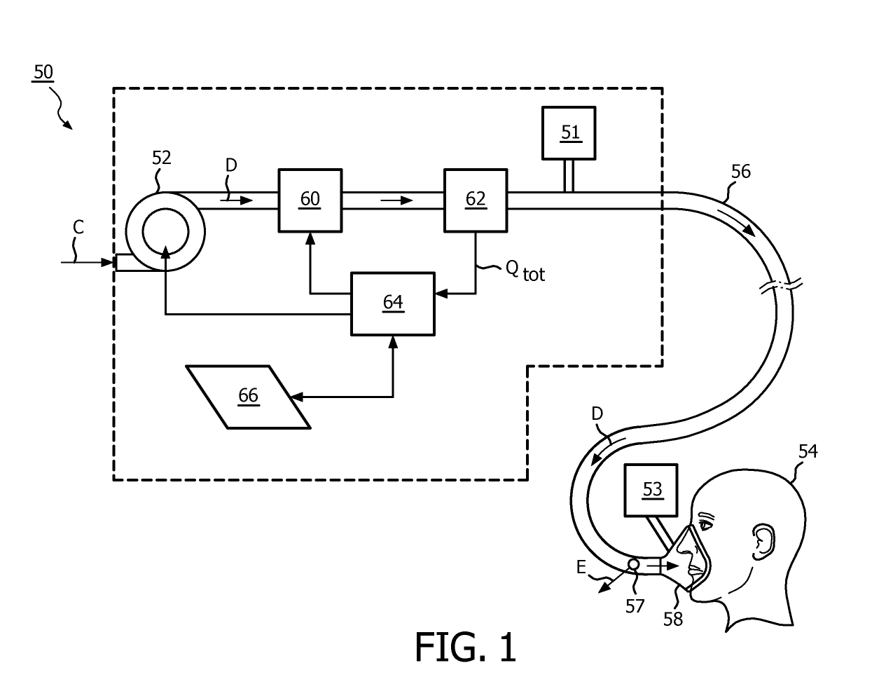

FIG. 1 is a schematic diagram of a pressure support system according to one particular, non-limiting embodiment in which the leak estimation methodology of the present invention may be implemented;

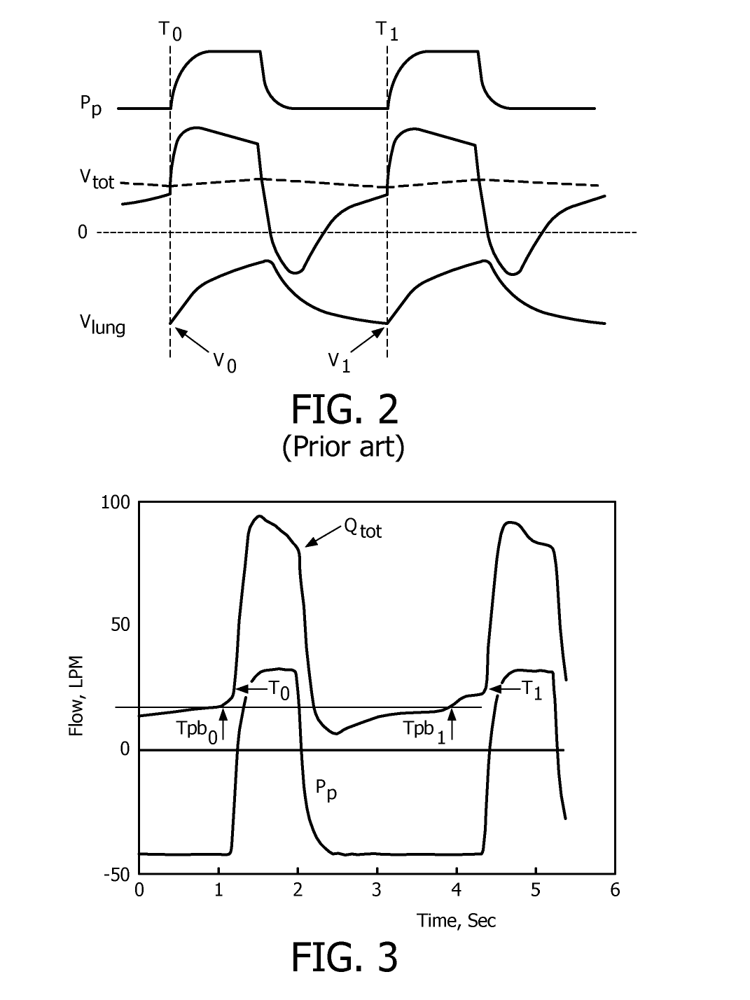

FIG. 2 is a graph illustrating a conventional method for determining integration limits for computing summations of total flow (Qₜₒₜ) and P^{γ} values; and

FIG. 3 is a graph illustrating a method for determining integration limits for computing summations of total flow (Qₜₒₜ) and P^{γ} values according to an aspect of an exemplary embodiment of the present invention.

As used herein, the singular form of “a”, “an”, and “the” include plural references unless the context clearly dictates otherwise. As used herein, the statement that two or more parts or components are “coupled” shall mean that the parts are joined or operate together either directly or indirectly, i.e., through one or more intermediate parts or components, so long as a link occurs. As used herein, “directly coupled” means that two elements are directly in contact with each other. As used herein, “fixedly coupled” or “fixed” means that two components are coupled so as to move as one while maintaining a constant orientation relative to each other.

As used herein, the word “unitary” means a component is created as a single piece or unit. That is, a component that includes pieces that are created separately and then coupled together as a unit is not a “unitary” component or body. As employed herein, the statement that two or more parts or components “engage” one another shall mean that the parts exert a force against one another either directly or through one or more intermediate parts or components. As employed herein, the term “number” shall mean one or an integer greater than one (i.e., a plurality).

Directional phrases used herein, such as, for example and without limitation, top, bottom, left, right, upper, lower, front, back, and derivatives thereof, relate to the orientation of the elements shown in the drawings and are not limiting upon the claims unless expressly recited therein.

As described in greater detail herein, the present invention solves many of the problems of existing leak estimation methods by providing an improved leak estimation methodology. FIG. 1 is a schematic diagram of pressure support system 50 according to one particular, non-limiting embodiment in which the leak estimation methodology of the present invention may be implemented. It should be understood that pressure support system 50 is meant to be exemplary only for purposes of illustrating and describing the present invention, and that the present invention may be implemented and employed in other types of gas delivery systems, such as, without limitation, a ventilator, such as an invasive ventilator system, that delivers volume controlled ventilation. One such alternative gas delivery system is described in PCT Publication No. WO 2010/044038, entitled “Volume Control in a Medical Ventilator,” assigned to the assignee of the present invention, the disclosure of which is incorporated herein by reference. Thus, the present invention may be employed in any type of gas delivery system having leaks where it is necessary or desirable to model leak flow.

Referring to FIG. 1, pressure support system 50 includes gas flow/pressure generator 52, such as a blower used in a conventional CPAP or bi-level pressure support device, piston, bellows, compressor, or any other device that receives breathing gas, generally indicated by arrow C, from any suitable source, e.g., a pressurized tank of oxygen or air, the ambient atmosphere, or a combination thereof. Gas flow/pressure generator 52 generates a flow of breathing gas, such as air, oxygen, or a mixture thereof, for delivery to an airway of a patient 54 at relatively higher and lower pressures, i.e., generally equal to or above ambient atmospheric pressure.

The pressurized flow of breathing gas, generally indicated by arrow D from gas flow/pressure generator 52 is delivered, via a delivery conduit 56, to breathing mask or patient interface 58 of any known construction, which is typically worn by or otherwise attached to patient 54 to communicate the flow of breathing gas to the airway of the patient. Delivery conduit 56 and patient interface device 58 are typically collectively referred to as a patient circuit.

Although not shown in FIG. 1, the present invention also contemplates providing a secondary flow of gas, either alone or in combination with the primary flow of gas (arrow C) from atmosphere. For example, a flow of oxygen from any suitable source, such as an oxygen concentrator, or oxygen storage device (liquid or gas), can be provided upstream of gas flow/pressure generator 52 or downstream of the gas flow generator, for example, in the patient circuit or at the patient interface device, to control the fraction of inspired oxygen delivered to the patient.

Pressure support system 50 shown in FIG. 1 is a single-limb system, meaning that the patient circuit includes only delivery conduit 56 connecting the patient to the pressure support device. As such, exhaust port 57 is provided in the delivery conduit 56 for venting exhaled gasses from the system to atmosphere as indicated by arrow E. It should be noted that exhaust port 57 can be provided at other locations in addition to or instead of in the delivery conduit, such as in the patient interface device 58. It should also be understood that exhaust port 57 can have a wide variety of configurations depending on the desired manner in which gas is to be vented from the pressure support system.

The present invention also contemplates that pressure support system 50 can be a two-limb system, having a delivery conduit and an exhaust conduit connected to patient 54. In a two-limb system (also referred to as a dual-limb system), the exhaust conduit carries exhaust gas from patient 54 and includes an exhaust valve at the end distal from patient 54. The exhaust valve in such an embodiment is typically actively controlled to maintain a desired level or pressure in the system, which is commonly known as positive end expiratory pressure (PEEP).

In the illustrated exemplary embodiment of the present invention, patient interface 58 is a nasal/oral mask. It is to be understood, however, that patient interface 58 can include a nasal mask, nasal pillows, tracheal tube, endotracheal tube, or any other device that provides the gas flow communicating function. Also, for purposes of the present invention, the phrase “patient interface” can include delivery conduit 56 and any other structures that connect the source of pressurized breathing gas to the patient.

It is also to be understood that various components may be provided in or coupled to the patient circuit. For example, a bacteria filter, pressure control valve, flow control valve, sensor, meter, pressure filter, humidifier and/or heater can be provided in or attached to the patient circuit. Likewise, other components, such as muffler and filters can be provided at the inlet of gas flow/pressure generator 52 and at the outlet of valve 60 (described below).

In the illustrated embodiment, pressure support system 50 includes a pressure controller in the form of valve 60 provided in delivery conduit 56. Valve 60 controls the pressure of the flow of breathing gas from gas flow/pressure generator 52 delivered to patient 54. For present purposes, gas flow/pressure generator 52 and valve 60 are collectively referred to as a “pressure generating system” because they act in concert to control the pressure and/or flow of gas delivered to the patient.

It should be apparent that other techniques for controlling the pressure delivered to the patient by the gas flow/pressure generator, such as varying the blower speed, either alone or in combination with a pressure control valve, are contemplated by the present invention. Thus, valve 60 is optional depending on the technique used to control the pressure of the flow of breathing gas delivered to the patient. If valve 60 is eliminated, the pressure generating system corresponds to gas flow/pressure generator 52 alone, and the pressure of gas in the patient circuit is controlled, for example, by controlling the motor speed of the gas flow/pressure generator.

Pressure support system 50 further includes flow sensor 62 that measures the flow of breathing gas within delivery conduit 56 (and thus the flow being output by pressure support system 50). In accordance with the exemplary embodiment shown in FIG. 1, flow sensor 62 is interposed in line with delivery conduit 56, most preferably downstream of valve 60. Flow sensor 62 generates a flow signal Qtot (which, as described elsewhere herein, is the measured total circuit flow) that is provided to controller 64.

Pressure support system 50 further includes one or more pressure sensors that measure the pressure in the patient circuit. As seen in FIG. 1, pressure sensor 51 measures the pressure near the ventilator outlet and pressure sensor 53 measures the pressure on or near patient interface 58. Either or both of these pressure sensors 51, 53 can be used to generate a pressure signal that is representative of the pressure at the source of the leak.

Processing element 64 receives (wired or wirelessly) pressure and flow signals from the pressure and flow sensors (51, 53, 62), respectively, in order to estimate Qleak.

Techniques for calculating the patient flow Qp based on Qtot are well known, and take into consideration the pressure drop of the patient circuit, known leaks from the system, i.e., the intentional exhausting of gas from the circuit as indicated by arrow E in FIG. 1, and unknown leaks from the system, such a leaks at the mask/patient interface. As stated elsewhere herein, the present invention provides an improved methodology for calculating leak flow Qleak (which is described in detail below), which may then be used in calculating Qp based on Qtot.

Controller 64 includes a processing portion which may be, for example, a microprocessor, a microcontroller or some other suitable processing device, and a memory portion that may be internal to the processing portion or operatively coupled to the processing portion and that provides a storage medium for data and software executable by the processing portion for controlling the operation of pressure support system 50, including estimating leak flow Qleak as described in greater detail herein.

Input/output device 66 is provided for setting various parameters used by the variable positive airway pressure support system, as well as for displaying and outputting information and data to a user, such as a clinician or caregiver. It is to be understood that the present invention contemplates providing input/output terminals so that the operation information and data collected by the pressure support system can be monitored and controlled remotely.

Having described an exemplary, non-limiting pressure support system 50 in which the leak estimation methodology of the present invention may be implemented, the leak estimation methodology of the present invention will now be described in detail, including an exemplary, non-limiting embodiment thereof. In addition, for illustrative purposes, the leak estimation methodology of the present invention will be described as being implemented in pressure support system 50. However, it will be understood that the leak estimation methodology of the present invention may be implemented in respiratory positive pressure support systems having different configurations.

The two types of leaks that are most common in clinical practice are the orifice leak and the variable geometry leak. The orifice leak is generated by small openings near or about a mask or interface, such as patient interface 58. The variable geometry leak typically occurs between the mask and the patient's face.

The general behavior (leak flow) of a leak, Qₗₑₐₖ, is given by:

Qₗₑₐₖ=G·P^{γ},

wherein G is the conductance coefficient, P is the pressure at or near to the leak, and γ is the exponent that describes the leak behavior with respect to pressure.

In the present invention, leak is modeled as a composite of the orifice with a first given γ value and variable geometry leak with a second given γ value. The exemplary embodiment described herein models leak as a composite of the orifice with a typical γ of between 0.0 and 0.7 (in one specific embodiment, the typical γ is between 0.5 and 0.7) and variable geometry leak whose γ ranges from 1 to 1.5. In the particular exemplary, non-limiting embodiment described herein and used for illustrative purposes, the orifice γ is set to 0.6 and the variable geometry leak γ is set to 1.2 (it will be appreciated that other particular values between 0.0 and 0.7 and 1 and 1.5, respectively, may also be used).

Thus, in the particular exemplary embodiment described herein, leak is rewritten as:

Qₗₑₐₖ=G_{orf}·P^{0.6}+G_{vg}·P^{1.2}.

Furthermore, pressure support system 50 does not directly measure leak, but instead uses the following method to estimate it. First, pressure support system 50 directly measures total flow, Qₜₒₜ, as described elsewhere herein using flow sensor 62. Pressure support system 50 also determines the pressure at the leak. This may be done by providing a pressure sensor as part of pressure support system 50 that directly measures the pressure of the gas within conduit 56, or may be determined from the operating parameters of pressure support system 50 as controlled by controller 64 (i.e., the current set pressure).

In addition, total flow, Qₜₒₜ, is the composite of the patent flow, Qₚ, and the total leak, Qₗₑₐₖ, and is given by the following:

Qₜₒₜ=Qₚ+Qₗₑₐₖ .

In order to remove Qₚ from the equation, the physiological observation that the volume of air inhaled is approximately the same as that exhaled is employed. Therefore, it can be shown that the average patient flow Qₚ is zero over the course of a single breath. It follows then that the average of the total flow Qₜₒₜ is given by the average of the leak flow Qₗₑₐₖ as set forth below:

Q̅ₜ̅ₒ̅ₜ̅= Q̅ₚ̅+ Q̅ₗ̅ₑ̅ₐ̅ₖ̅.

And since Q̅ₚ̅=0 over any interval where the lung volumes are equivalent at the start and termination of the interval, then the following is true:

Q̅ₜ̅ₒ̅ₜ̅= Q̅ₗ̅ₑ̅ₐ̅ₖ̅.

In quantities that can be measured in practice, the average operator can be applied to the leak equation:

Qₗₑₐₖ=G_{orf}·P^{0.6}+G_{vg}·P^{1.2},

and the above equality ( Q̅ₜ̅ₒ̅ₜ̅= Q̅ₗ̅ₑ̅ₐ̅ₖ̅) applied to the leak equation yields the following:

Q̅ₜ̅ₒ̅ₜ̅=G_{orf}· P̅^̅{̅0̅.̅6̅}̅+G_{vg}· P̅^̅{̅1̅.̅2̅}̅.

Furthermore, a collection of a number of breaths, for example five breaths, will form a series of simultaneous equations as set forth below:

Q̅_̅{̅t̅o̅t̅ 1̅}̅=G_{orf}· P̅^̅{̅0̅.̅6̅}̅₁̅+G_{vg}· P̅^̅{̅1̅.̅2̅}̅₁̅

Q̅_̅{̅t̅o̅t̅ 2̅}̅=G_{orf}· P̅^̅{̅0̅.̅6̅}̅₂̅+G_{vg}· P̅^̅{̅1̅.̅2̅}̅₂̅

Q̅_̅{̅t̅o̅t̅ 5̅}̅=G_{orf}· P̅^̅{̅0̅.̅6̅}̅₅̅+G_{vg}· P̅^̅{̅1̅.̅2̅}̅₅̅s

In matrix form, those equations may be represented as follows:

$$Q ] = [ P ] . \cdot G ] , \\ where \\ Q ] = [ \begin{matrix}\overline{{Q}_{tot 1}} \\ \overline{{Q}_{tot 2}} \\ \\ \overline{{Q}_{tot 5}}\end{matrix} ] \\ [ P ] = [ \begin{matrix}\overline{{P}_{1}^{0.6}} & \overline{{P}_{1}^{1.0}} \\ \overline{{P}_{2}^{0.6}} & \overline{{P}_{2}^{1.2}} \\ & \\ \overline{{P}_{5}^{0.6}} & \overline{{P}_{5}^{1.2}}\end{matrix} ] \\ G ] = [ \begin{matrix}{G}_{orf} \\ {G}_{vg}\end{matrix} ] .$$

In these equations, each of the average Qₜₒₜ and average P values is known (measured), and therefore the unknowns are G_{orf} and G_{vg}. If one is able to solve for G_{orf} and G_{vg}, then those values may be used in the leak equation set forth above (Qₗₑₐₖ=G_{orf}·P^{0.6}+G_{vg}·P^{1.2}) in order to determine leak flow.

There are several methods to solve these equations for the conductance coefficients G_{orf} and G_{vg}. One method is to employ the least squares method.

G]=[[P]^{T}[P]]⁻¹·[P]^{T}Q]

The problem with this solution is that the column vectors of [P] often approach linear dependence and thus the inverse matrix contains excessively large numbers which amplify noise in the Q] vector. Moreover, the confidence interval of G] becomes excessively large rendering the result unusable for leak estimation. Predicting this situation is numerically involved and when the inverse becomes unstable the solution is to reduce the order of the matrix implying that one or more of the basis vectors must be dropped. After each breath the process needs to be repeated to produce an updated G].

Another method to solve the system of equations is use the least-mean-squares (LMS) adaptive algorithm. First introduced in the 70's by Dr. Bernard Widrow, the LMS algorithm is very simple to implement. The general formulation adapted for the problem at hand is:

E]=Q]−[P]·G]

G]=G]+μ[P]^{T} E],

where μ is the convergence factor. The problem with this method is that it is also susceptible to the column vectors in the matrix [P] becoming linearly dependent. But unlike the least-square method discussed above, the solution here does not excessively amplify noise in the Q]. However, the values of G will not necessarily converge to those in the true G] but will still minimize the mean power of the error vector E].

In order for the least squares or the least-mean-squares to find G_{orf} and G_{vg}, there must be some variability in pressure profile (PPV) from breath to breath in order for the columns in [P] to show some linear independence. The more variability in the breath to breath pressure profile, the more linearly independent the columns in [P] become. In the absence of sufficient PPV, the order of the system (number of columns in [P]) must be reduced to arrive at stable numeric solution.

The condition of the matrix [P]^{T}[P] can be determined by examining the determinant or other methods. However, CPU time and memory space are at a premium in ventilators so a numerically simple and robust method that lend itself to integer implementation and to a reasonable exception handling algorithm is required.

The design goal is to adjust the number of columns in [P] to the level of PPV such that the resulting G] values have acceptable accuracy and are well-behaved. One of the simplest methods accomplishing the stated compound goal is to apply Gram-Schmidt orthogonalization to the [P] matrix in order to produce an orthogonal matrix [U]. Two benefits are enjoyed as the result of this operation. First, the relative lengths or Euclidean distances of the resulting column vectors in [U] can be directly used to determine the order of the system. Second, the LMS algorithm optimally performs when the inputs (in this case the columns in [U]) are orthogonal.

To avoid confusion in notation, the LMS coefficients H] are used with the orthogonal input of [U]. Updating H]ₖ for the kth breath may be done as follows:

E]=Q]−[U]·H]ₖ

H]ₖ₊₁=H]ₖ+μ[U]^{T} E].

H] can then be converted back into G] form to obtain the conductance coefficients G_{orf} and G_{vg} in order to then compute the instantaneous leak using:

Qₗₑₐₖ=G_{orf}·P^{0.6}+G_{vg}·P^{1.2}.

As described elsewhere herein, in the exemplary embodiment of the present invention it is necessary to determine average total flow ( Q̅ₜ̅ₒ̅ₜ̅)and average P^{γ} values ( P̅^̅{̅γ̅1̅}̅ and P̅^̅{̅γ̅2̅}̅) for each of a number of breaths. Such determinations require total flow and P^{γ} values to be summed over each breath. In the exemplary embodiment, in order for the summations to yield proper averages over each breath, the start and stop times (T₀ and T₁) for the summations (the integration limits) should be chosen such that the lung volumes at the start and stop times are substantially equivalent. FIG. 2 shows the conventional method for determining the integration limits for computing the summations of total flow (Qₜₒₜ) and P^{γ} values. In this conventional method, T₀ is the beginning of the inspiratory phase of the breath and T₁ is the end of the expiratory phase of the breath (i.e., the beginning of the inspiratory phase of the next breath). The underlying assumption in this conventional method is that V0 and V1 are equivalent. In a perfect scenario where the Pmus drive and the triggering is identical at T0 and T1, then this is true. However, in the clinical setting, these assumptions are not true and thus an enhancement in placing the integral limits is called for. A more advantageous place for doing this is during the last moments of the expiratory phase where the lung flow is minimal and just prior to the beginning of the inspiratory muscle pressure and beginning of the pressure support.

Thus, the following is one particular manner in which the summations may be determined that addresses the problems present in the clinical setting as just described. The idea is to move T₀ and T₁ back in time (to Tpb₀ and Tpb₁, respectively) such that they are out of the inspiratory phase and such that Qₜₒₜ(Tpb₀)≅Qₜₒₜ(Tpb₁). The pressure delivered to the patient is equal at times Tpb₀ and Tpb₁. The respiratory muscle drive is effectively zero at these points in time as well. Therefore, it can be shown that if the respiratory time constants of the pulmonary system is consistent from one breath to the next then equating Qtot at times Tpb₀ and Tpb₁ essentially equates the lung volumes at these points in time as well. As guidance, substantial equivalence is considered to be present when Qₜₒₜ(Tpb₀) and Qₜₒₜ(Tpb₁) are within 1 LPM of each other.

In one particular embodiment, the algorithm for moving T₀, T₁ to Tpb₀, Tpb₁ is as follows. First, Tpb₀ is set equal to T₀ and Tpb₁ is set equal to T_{1,} wherein T₀ is the beginning of the inspiratory phase of the breath and T₁ is the end of the expiratory phase of the breath (i.e., the beginning of the inspiratory phase of the next breath). Then, the Tpb with the higher Qₜₒₜ value associated with it is moved back (pushed back) in time until: (i) Qₜₒₜ(Tpb₀) equals Qₜₒₜ(Tpb₁) or (ii) the pushback period (T−Tpb) has exceeded the minimum of either 300 ms (or some other predetermined time period; note, 300 ms may be reduced as respiratory rate increases) or ¼ (or some other predetermined portion) of the expiratory period. The rationale is that the ventilator likely triggered shortly after the onset of inspiration where the respiratory muscles started contracting. This operation seeks to push back the integral limits to a time prior to the onset of inspiratory drive and to a point where the lung volumes at Tpb₀ and Tpb₁ are equivalent. Then, both Tpb₀ and Tpb₁ are moved back 150 ms (or some other predetermined time period; note, 150 ms may be reduced as respiratory rate increases) to back away from non-zero Pmus and Pp. Finally, the Tpb with the higher Qₜₒₜ value associated with it is moved back in time until: (i) Qₜₒₜ(Tpb₀) equals Qₜₒₜ(Tpb₁) or (ii) the pushback period (T−Tpb) has exceeded ⅓ (or some other predetermined portion) of the expiratory period. The determined Tpb₀ and Tpb₁ are then used at the starting and stopping points (the integration limits) for the summations of total flow (Qₜₒₜ) and P^{γ} values. This method is illustrated in FIG. 3.

In alternative embodiments, the average operator for total flow Qₜₒₜ and P^{γ} described in the embodiments above may be replaced with a summation operator or an integral operation such that summations of total flow Qₜₒₜ and P^{γ} are used in the implementation of the invention. In such embodiments, the invention would include determining a total flow value (Qtotᵥ) of the gas delivery system for each of N breaths, wherein Qtotᵥ is one of average total flow Q̅ₜ̅ₒ̅ₜ̅, summation of total flow or integral of total flow, determining a P^{γ1} value (P^{γ1}ᵥ) and a P^{γ2} value (P^{γ2}ᵥ) for each of the N breaths, wherein P is a leak pressure of the gas delivery system, γ1 is a first predetermined value, γ2 is a second predetermined value, wherein P^{γ1}ᵥ and P^{γ2}ᵥ are one of averages P̅^̅{̅γ̅1̅}̅ and P̅^̅{̅γ̅2̅}̅ for the breath, summations of P^{γ1} and P^{γ2} for the breath or integrals of P^{γ1} and P^{γ2} for the breath, setting up a system of N equations, one for each of the N breaths, wherein each of the equations has the form Qtotᵥ=G_{orf}·P^{γ1}ᵥ+G_{vg}·P^{γ2}ᵥ and uses the determined Qtotᵥ, P^{γ1}ᵥ and P^{γ2}ᵥ for the associated breath, solving the system of N equations for G_{orf} and G_{vg}, and using G_{orf} and G_{vg} to calculate instantaneous leak Qₗₑₐₖ using Qₗₑₐₖ=G_{orf}·P^{γ1}+G_{vg}·P^{γ2}.

It can be appreciated from the foregoing that the present invention provides an improvement in the area of leak estimation for gas delivery systems, such as, without limitation, positive pressure support systems or invasive ventilator systems, particularly in cases, such as when high pressure support levels are employed, where errors in leak estimation will be amplified.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

1. A method of estimating leak flow in a gas delivery system, comprising:
determining a total flow value (Qtotᵥ) of the gas delivery system for each of N breaths, wherein Qtotᵥ is one of average total flow Q̅ₜ̅ₒ̅ₜ̅, summation of total flow or integral of total flow;
determining a P^{γ1} value (P^{γ1}ᵥ) and a P^{γ2} value (P^{γ2}ᵥ) for each of the N breaths, wherein P is a leak pressure of the gas delivery system, γ1 is a first predetermined value, γ2 is a second predetermined value, and wherein P^{γ1}ᵥ and P^{γ2}ᵥ are one of averages P̅^̅{̅γ̅1̅}̅ and P̅^̅{̅γ̅2̅}̅ for the breath, summations of P^{γ1} and P^{γ2} for the breath or integrals of P^{γ1} and P^{γ2} for the breath;
setting up a system of N equations, one for each of the N breaths, wherein each of the equations has the form Qtotᵥ=G_{orf}·P^{γ1}ᵥ+G_{vg}·P^{γ2}ᵥ and uses the determined Qtotᵥ, P^{γ1}ᵥ and P^{γ2}ᵥ for the associated breath;
solving the system of N equations for G_{orf} and G_{vg}; and
using G_{orf} and G_{vg} to calculate instantaneous leak Qₗₑₐₖ using Qₗₑₐₖ=G_{orf}·P^{γ1}+G_{vg}·P^{γ2}.

2. The method according to claim 1, wherein the determining the total flow value comprises determining an average total flow Q̅ₜ̅ₒ̅ₜ̅ of the gas delivery system for each of N breaths, wherein the determining the P^{γ1} value (P^{γ1}ᵥ) and the P^{γ2} value (P^{γ2}ᵥ) comprises determining P̅^̅{̅γ̅1̅}̅ and P̅^̅{̅γ̅2̅}̅ for each of the N breaths, wherein P̅^̅{̅γ̅1̅}̅ and P̅^̅{̅γ̅2̅}̅ are averages for the breath, and wherein the setting up the system of N equations comprises setting up a system of N equations, one for each of the N breaths, wherein each of the equations has the form Q̅ₜ̅ₒ̅ₜ̅=G_{orf}· P̅^̅{̅γ̅1̅}̅+G_{vg}· P̅^̅{̅γ̅2̅}̅ and uses the determined Q̅ₜ̅ₒ̅ₜ̅, P̅^̅{̅γ̅1̅}̅ and P̅^̅{̅γ̅2̅}̅ for the associated breath.

3. The method according to claim 1, wherein and γ1 is between 0.0 and 0.7.

4. The method according to claim 1, wherein and γ2 is between 1 and 1.5.

5. The method according to claim 1, wherein γ1 is between 0.0 and 0.7 and γ2 is between 1 and 1.5.

6. The method according to claim 5, wherein and γ1 is 0.6.

7. The method according to claim 6, wherein and γ2 is 1.2.

8. The method according to claim 2, wherein the system of N equations is written in matrix form as Q]=[P]·G], where:
$$Q ] = [ \begin{matrix}\overline{{Q}_{tot 1}} \\ \\ \overline{{Q}_{tot n}}\end{matrix} ] \\ [ P ] = [ \begin{matrix}\overline{{P}_{1}^{γ 1}} & \overline{{P}_{1}^{γ 2}} \\ & \\ \overline{{P}_{n}^{γ 1}} & \overline{{P}_{n}^{γ 2}}\end{matrix} ] \\ G ] = [ \begin{matrix}{G}_{orf} \\ {G}_{vg}\end{matrix} ] .$$

9. The method according to claim 8, wherein the solving the system of N equations for G_{orf} and G_{vg} comprises using the least-mean-squares (LMS) adaptive algorithm to solve the system of N equations for G_{orf} and G_{vg}.

10. The method according to claim 9, wherein the solving the system of N equations for G_{orf} and G_{vg} comprises performing Gram-Schmidt orthogonalization to [P] order to produce an orthogonal matrix [U] and using the orthogonal matrix [U] in the least-mean-squares (LMS) adaptive algorithm.

11. The method according to claim 8, wherein the solving the system of N equations for G_{orf} and G_{vg} comprises using the least squares to solve the system of N equations for G_{orf} and G_{vg}.

12. The method according to claim 2, wherein the determining Q̅ₜ̅ₒ̅ₜ̅ and P̅^̅{̅γ̅1̅}̅ and P̅^̅{̅γ̅2̅}̅ for each of the N breaths requires summations of Qₜₒₜ, P^{γ1} and P^{γ2} to be performed for each of the N breaths, and wherein a starting point for each summation in each breath is during an end of the expiratory phase of a preceding breath immediately prior to the breath a stopping point for each summation in each breath is during an end of the expiratory phase of the breath.

13. The method according to claim 12, wherein for each summation in each breath the Qₜₒₜ associated with the starting point of the summation and the Qₜₒₜ associated with the stopping point of the summation are substantially equal to one another.

14. A gas delivery system, comprising:
a pressure generating system adapted to produce a first flow of gas;
a patient circuit operatively coupled to the pressure generating system; and
a controller operatively coupled to the pressure generating system, the controller being programmed to estimate leak flow in the gas delivery system by:
determining a total flow value (Qtotᵥ) of the gas delivery system for each of N breaths, wherein Qtotᵥ is one of average total flow Q̅ₜ̅ₒ̅ₜ̅, summation of total flow or integral of total flow;
determining a P^{γ1} value (P^{γ1}ᵥ) and a P^{γ2} value (P^{γ2}ᵥ) for each of the N breaths, wherein P is a leak pressure of the gas delivery system, γ1 is a first predetermined value, γ2 is a second predetermined value, wherein P^{γ1}ᵥ and P^{γ2}ᵥ are one of averages P̅^̅{̅γ̅1̅}̅ and P̅^̅{̅γ̅2̅}̅ for the breath, summations of P^{γ1} and P^{γ2} for the breath or integrals of P^{γ1} and P^{γ2} for the breath;
setting up a system of N equations, one for each of the N breaths, wherein each of the equations has the form Qtotᵥ=G_{orf}·P^{γ1}ᵥ+G_{vg}·P^{γ2}ᵥ and uses the determined Qtotᵥ, P^{γ1}ᵥ and P^{γ2}ᵥ for the associated breath;
solving the system of N equations for G_{orf} and G_{vg}; and
using G_{orf} and G_{vg} to calculate instantaneous leak Qₗₑₐₖ using Qₗₑₐₖ=G_{orf}·P^{γ1}+G_{vg}·P^{γ2}.

15. The gas delivery system according to claim 14, wherein:
the determining the total flow value comprises determining an average total flow Q̅ₜ̅ₒ̅ₜ̅ of the gas delivery system for each of N breaths;
the determining the P^{γ1} value (P^{γ1}ᵥ) and the P^{γ2} value (P^{γ2}ᵥ) comprises determining P̅^̅{̅γ̅1̅}̅ and P̅^̅{̅γ̅2̅}̅ for each of the N breaths, wherein P̅^̅{̅γ̅1̅}̅ and P̅^̅{̅γ̅2̅}̅ are averages for the breath;
the setting up the system of N equations comprises setting up a system of N equations, one for each of the N breaths, wherein each of the equations has the form Q̅ₜ̅ₒ̅ₜ̅=G_{orf}· P̅^̅{̅γ̅1̅}̅+G_{vg}· P̅^̅{̅γ̅2̅}̅ and uses the determined Q̅ₜ̅ₒ̅ₜ̅, P̅^̅{̅γ̅1̅}̅ and P̅^̅{̅γ̅2̅}̅ for the associated breath.

16. The gas delivery system according to claim 14, wherein and γ1 is between 0.0 and 0.7.

17. The gas delivery system according to claim 14, wherein and γ2 is between 1 and 1.5.

18. The gas delivery system according to claim 14, wherein γ1 is between 0.0 and 0.7 and γ2 is between 1 and 1.5.

19. The gas delivery according to claim 18, wherein and γ1 is 0.6.

20. The gas delivery system according to claim 19, wherein and γ2 is 1.2.

21. The gas delivery system according to claim 15, wherein the system of N equations is written in matrix form as Q]=[P]·G], where:
$$Q ] = [ \begin{matrix}\overline{{Q}_{tot 1}} \\ \\ \overline{{Q}_{tot n}}\end{matrix} ] \\ [ P ] = [ \begin{matrix}\overline{{P}_{1}^{γ 1}} & \overline{{P}_{1}^{γ 2}} \\ & \\ \overline{{P}_{n}^{γ 1}} & \overline{{P}_{n}^{γ 2}}\end{matrix} ] \\ G ] = [ \begin{matrix}{G}_{orf} \\ {G}_{vg}\end{matrix} ] .$$

22. The gas delivery system according to claim 21, wherein the solving the system of N equations for G_{orf} and G_{vg} comprises using the least-mean-squares (LMS) adaptive algorithm to solve the system of N equations for G_{orf} and G_{vg}.

23. The gas delivery system according to claim 22, wherein the solving the system of N equations for G_{orf} and G_{vg} comprises performing Gram-Schmidt orthogonalization to [P] order to produce an orthogonal matrix [U] and using the orthogonal matrix [U] in the least-mean-squares (LMS) adaptive algorithm.

24. The gas delivery system according to claim 21, wherein the solving the system of N equations for G_{orf} and G_{vg} comprises using the least squares to solve the system of N equations for G_{orf} and G_{vg}.

25. The gas delivery system according to claim 15, wherein the determining Q̅ₜ̅ₒ̅ₜ̅ and P̅^̅{̅γ̅1̅}̅ and P̅^̅{̅γ̅2̅}̅ for each of the N breaths requires summations of Qₜₒₜ, P^{γ1} and P^{γ2} to be performed for each of the N breaths, and wherein a starting point for each summation in each breath is during an end of the expiratory phase of a preceding breath immediately prior to the breath a stopping point for each summation in each breath is during an end of the expiratory phase of the breath.

26. The gas delivery system according to claim 25, wherein for each summation in each breath the Qₜₒₜ associated with the starting point of the summation and the Qₜₒₜ associated with the stopping point of the summation are substantially equal to one another.
